(19) United States
(12) Patent Application Publication
(10) Pub. No.: US 2003/0050218 A1
(43) Pub. Date: Mar. 13, 2003

(54) Preformulated additive for a composition for treating textile fiber articles and use of said additive as care agent

(76) Inventors: Cedric Geffroy, Poitiers (FR); Ian Harrison, Poissy (FR)

Correspondence Address: Rhodia Inc., 259 Prospect Plains Road, CN 7500, CRANBURY, NJ, 08512, US

(21) Appl. No.: 10/218,613

(22) Filed: Aug. 14, 2002

(30) Foreign Application Priority Data
Aug. 22, 2001 (FR) 01 11000

(51) Int. Cl. C11D 17/00

(52) U.S. Cl. 510/475; 510/445; 8/115.51

(57) ABSTRACT

Preformulated additive for a composition for treating textile fiber articles in aqueous or wet medium, comprising: a particulate solid organic polymer (P) dispersed in and/or encapsulated by a matrix (M) and a surfactant (S) at the matrix (M)/polymer (P) interface, said matrix (M) being soluble or dispersible in said medium and the polymer (P) insoluble and capable of dispersing in said medium in the form of nanoparticles. Use of the preformulated additive as care agent, in particular as crease-resistance agent, in detergent formulations, rinsing/softening formulations, tumble dryer additives and washing additives for textile fiber articles.

The subject of the present invention is a preformulated additive for a composition for treating textile fiber articles, compositions comprising said additive; its subject is also the use of said additive, in the compositions for treating textile fiber articles, as care agent for said articles, in particular as crease-resistance agent; it also relates to said treatment compositions.

The expression care of textile fiber articles means protecting the latter against physical or chemical degradation and/or giving them advantages such as softening and/or crease-resistance properties; giving a crease-resistance advantage is more particularly sought.

A first subject of the invention consists of a preformulated additive for a composition for treating textile fiber articles in aqueous or wet medium, characterized:

in that it comprises:

at least one particulate solid organic polymer (P) dispersed in and/or encapsulated by a matrix (M) made of at least one organic or inorganic compound

and at least one surfactant (S) at the matrix (M)/polymer (P) interface

in that said matrix (M) is soluble or dispersible in said medium

and in that said polymer (P) is insoluble and capable of dispersing in said medium in the form of nanoparticles.

For a good implementation of the invention, said preformulated additive comprises, expressed on a dry basis:

from 5 to 90%, preferably from 10 to 60%, of its weight of polymer (P)

from 3-90%, preferably from 10 to 80%, most particularly from 15 to 75%, of its weight of matrix (M)

from 0.01 to 20%, preferably from 0.02 to 5%, by weight of surfactant (S).

The terms “dispersible” or “to disperse” mean that no aggregates form in the medium.

Preferably, said polymer (P) has a glass transition temperature Tg of the order of −40° C. to 150° C., preferably of the order of −40° C. to 100° C., most particularly of the order of −40° C. to 40° C.

The term “polymer” means both a homopolymer and a copolymer derived from two or more monomers.

For good implementation of the invention, said polymer (P) comprises:

hydrophobic monomer units (N) that are uncharged or non-ionizable at the working pH of the composition of the invention,

optionally at least one hydrophilic monomer unit (F) chosen from monomer units

(F1) that are cationic or cationizable at the working pH of said composition,

(F2) that are amphoteric at the working pH of said composition,

(F3) that are anionic or anionizable at the working pH of said composition,

(F4) that are uncharged or non-ionizable, of hydrophilic nature, at the working pH of said composition,

or mixtures thereof

and optionally at least one crosslinking unit (R).

Said monomer units (N) and (F) are preferably derived from α-β monoethylenically unsaturated monomers.

Said monomer units (R) are preferably derived from diethylenically unsaturated monomers.

The average molar mass of said polymer (measured by gel permeation chromatography (GPC) THF and expressed as polystyrene equivalents) may preferably be at least 20,000.

As examples of monomers from which the hydrophobic units (N) are derived, mention may be made of:

vinylaromatic monomers such as styrene, vinyltoluene, etc.,

alkyl esters of α-β monoethylenically unsaturated acids such as linear or branched C₁-C₁₀ alkyl acrylates and methacrylates such as methyl, ethyl, butyl, isobutyl, heptyl, nonyl, etc. acrylates and methacrylates,

vinyl or allyl esters of saturated carboxylic acids, such as vinyl or allyl acetates, propionates or versatates,

α-β monoethylenically unsaturated nitrites, such as acrylonitrile, etc.

α-olefins such as ethylene, etc.

As examples of monomers from which the cationic or cationizable hydrophilic units (F1) are derived, mention may be made of:

N,N-(dialkylamino-ω-alkyl)amides of α-β monoethylenically unsaturated carboxylic acids such as N,N-dimethylaminomethyl acrylamide or methacrylamide, N,N-dimethylaminoethyl acrylamide or methacrylamide, N,N-dimethylamino-3-propyl acrylamide or methacrylamide and N,N-dimethylaminobutyl acrylamide or methacrylamide,

α-β monoethylenically unsaturated amino esters, such as dimethylaminoethyl methacrylate (DMAM), dimethylaminopropyl methacrylate, di-tert-butylaminoethyl methacrylate or dipentylaminoethyl methacrylate,

monomers that are precursors of amine functions, such as N-vinylformamide, N-vinylacetamide, etc., which generate primary amine functions by simple acidic or basic hydrolysis.

As examples of monomers from which the amphoteric hydrophilic units (F2) are derived, mention may be made of:

N,N-dimethyl-N-methacryloyloxyethyl-N-(3-sulfopropyl)ammonium sulfobetaine (SPE from Raschig), N,N-dimethyl-N-(2-methacrylamidoethyl)-N-(3-sulfopropyl)ammonium betaine (SPP from Raschig), 1-vinyl-3-(3-sulfopropyl)imidazolidium betaine or 1-(3-sulfopropyl)-2-vinylpyridinium betaine (SPV from Raschig),

derivatives of the quaternization reaction of N-(dialkylamino-ω-alkyl)amides of α-β ethylenically unsaturated carboxylic acids, such as N,N-dimethylaminomethyl acrylamide or methacrylamide, N,N-dimethylamino-3-propyl acrylamide or methacrylamide, or ethylenically unsaturated amino esters, such as di-tert-butylaminoethyl methacrylate or dipentylaminoethyl methacrylate, with a chloroacetate of alkali metal (in particular sodium) or of propane sultone.

As examples of monomers from which the anionic or anionizable hydrophilic units (F3) are derived, mention may be made of:

monomers containing at least one carboxylic function, such as α-β ethylenically unsaturated carboxylic acids or anhydrides, acrylic, methacrylic, maleic, fumaric or itaconic acids or anhydrides, N-methacroylalanine or N-acryloylhydroxyglycine, and water-soluble salts thereof,

monomers containing at least one sulfate or sulfonate function, such as 2-sulfooxyethyl methacrylate, vinylbenzenesulfonic acid, allylsulfonic acid, 2-acrylamido-2-methylpropanesulfonic acid, sulfoethyl acrylate or methacrylate, or sulfopropyl acrylate or methacrylate, and water-soluble salts thereof,

monomers containing at least one phosphonate or phosphate function, such as vinylphosphonic acid, esters of ethylenically unsaturated phosphates such as phosphates derived from hydroxyethyl methacrylate (Empicryl 6835 from Rhodia) and those derived from polyoxyalkylene methacrylates and water-soluble salts thereof,

α-β monoethylenically unsaturated monomers that are precursors of anionic function(s), such as those whose hydrolysis generates carboxylate functions (tert-butyl acrylate, dimethylaminoethyl acrylate, maleic anhydride, etc.).

As examples of monomers from which the uncharged or non-ionizable hydrophilic units (F4) are derived, mention may be made of:

hydroxyalkyl esters of α-β ethylenically unsaturated acids, such as hydroxyethyl, hydroxypropyl, etc. α-β acrylates and methacrylates,

α-β ethylenically unsaturated acid amides, such as acrylamide, N,N-dimethyl methacrylamide, N-methylolacrylamide, etc.,

α-β ethylenically unsaturated monomers bearing a water-soluble polyoxyalkylenated segment of the polyethylene oxide type, such as polyethylene oxide α-methacrylates (Bisomer S20W, S10W, etc. from Laporte) or α,ω-dimethacrylates, Sipomer BEM from Rhodia (polyoxyethylene ω-behenyl methacrylate), Sipomer SEM-25 from Rhodia (polyoxyethylene ω-tristyrylphenyl methacrylate), etc.,

α-β ethylenically unsaturated monomers that are precursors of hydrophilic units or segments, such as vinyl acetate, which, once polymerized, may be hydrolysed to generate vinyl alcohol units or of polyvinyl alcohol segments,

α-β ethylenically unsaturated monomers of ureido type and in particular methacrylamidoethyl-2-imidazolidinone (Sipomer WAM II from Rhodia).

As examples of monomers from which the crosslinking units (R) are derived, mention may be made of:

divinylbenzene

ethylene glycol dimethacrylate

allyl methacrylate

methylenebis(acrylamide)

glyoxal bis(acrylamide)

butadiene.

According to the invention, the expression nanoparticles of polymer means particles having a diameter of the order of from 10 to 500 nm, preferably from 20 to 300 nm, most particularly from 20 to 100 nm, still more particularly from 20 to 50 nm.

The diameter of said particles may be determined in a well-known manner by light scattering or by transmission electron microscopy.

Said polymers (P) may be obtained in a known manner by free-radical polymerization in aqueous medium of ethylenically unsaturated monomers, in particular by free-radical emulsion polymerization in water.

Processes for obtaining particulate latices of small size are described in Colloid Polym. Sci. 266:462-469 (1988) and in Journal of Colloid and Interface Science. Vol. 89, No. 1, September 1982, pages 185 et seq. One method for preparing latices of particles with a mean size of less than 100 nm, in particular with a mean size ranging from 1 to 60 nm and most particularly from 5 to 40 nm, is described in EP-A-644 205.

The choice and relative amounts of the monomer(s) from which the unit(s) (N), (F) and (R) of the polymer (P) are derived are such that said polymer (P) has a glass transition temperature Tg of the order of from −40° C. to 150° C., preferably of the order of from −40° C. to 100° C. and most particularly of the order of from −40° C. to 40° C., and remains insoluble under the working conditions of the additive of the invention.

According to the invention, said polymer (P) is considered as insoluble when less than 15% and preferably less than 10% of its weight is soluble in the aqueous or wet working medium of the additive of the invention, that is to say in particular under the temperature and pH conditions of said medium.

Among the compounds capable of forming the matrix (M), mention may be made of the following water-soluble or water-dispersible organic and inorganic compounds:

water-soluble or water-dispersible polypeptides (PP) of natural or synthetic origin

polyelectrolytes (PE) in acid form, belonging to the family of weak polyacids, having a molecular mass of less than 20,000 g/mol, preferably between 1,000 and 5,000 g/mol

polyethylene glycols (PEG) having a molecular mass of between 4,000 and 100,000 g/mol

polyvinylpyrrolidones (PVP) having a molecular mass of less than 20,000 g/mol, preferably between 1,000 and 10,000 g/mol

polyvinyl alcohols (PVA) having a molecular mass of less than 100,000 g/mol, and preferably having a deacetylation value of from 80 to 99 mol%, preferably from 87 to 95 mol%

water-soluble or water-dispersible film-forming ampholytic polymers (AP)

water-soluble or water-dispersible monosaccharides, saccharides or polysaccharides (O)

amino acids (AA) or water-soluble or water-dispersible salts of amino acids

urea

surfactants (TA) whose water-surfactant binary phase diagram comprises an isotropic phase which is fluid at 25° C. up to a concentration of at least 50% by weight of surfactant, followed by a rigid liquid crystal phase of the hexagonal or cubic type at higher concentrations, which is stable at least up to 60° C.

water-soluble or water-dispersible alkali metal or alkaline-earth metal silicates (Sil) and phosphates (Phos)

or mixtures thereof.

Among the water-soluble or water-dispersible synthetic polypeptides (PP), mention may be made of homopolymers or copolymers derived from the polycondensation of amino acids or amino acid precursors, in particular of aspartic acid and glutamic acid or precursors thereof, and hydrolysis. These polymers can be not only homopolymers derived from aspartic acid or glutamic acid but also copolymers derived from aspartic acid and glutamic acid in all proportions, or copolymers derived from aspartic acid and/or glutamic acid and from other amino acids. Among the copolymerizable amino acids which may be mentioned are glycine, alanine, leucine, isoleucine, phenylalanine, methionine, histidine, proline, lysine, serine, threonine, cysteine, etc.

Among the polypeptides (PP) of plant origin, mention may be made of proteins of plant origin; these are preferably hydrolyzed, with a degree of hydrolysis of less than or equal to 40%, for example from 5% to less than 40%.

Among the proteins of plant origin which may be mentioned as a guide are proteins originating from proteaginous seeds, in particular those of pea, bean, lupin, haricot and lentil; proteins originating from cereal seeds, in particular those of wheat, barley, rye, corn, rice, oat and millet; proteins originating from oleaginous seeds, in particular those of soya, groundnut, sunflower, rape and coconut; proteins originating from leaves, in particular from alfalfa and nettles; and proteins originating from underground reserves of plant organs, in particular those of potato and beetroot.

Among the proteins of animal origin which may be mentioned, for example, are muscle proteins, in particular proteins of the stroma, and gelatin; proteins originating from milk, in particular casein and lactoglobulin; and fish proteins.

The protein is preferably of plant origin, and more particularly originates from soya or wheat.

The polyelectrolyte (PE) can be chosen from those derived from the polymerization of monomers which have the following general formula

(R¹) (R²)C═C(R³)COOH

in which formula R¹, R² and R³ are identical or different and represent

a hydrogen atom,

a hydrocarbon-based radical containing from 1 to 4 carbon atoms, preferably methyl,

a —COOH function,

a radical —R—COOH, in which R represents a hydrocarbon-based residue containing from 1 to 4 carbon atoms, preferably an alkylene residue containing 1 or 2 carbon atoms, most particularly methylene.

Non-limiting examples which may be mentioned are acrylic acid, methacrylic acid, maleic acid, fumaric acid, itaconic acid and crotonic acid.

Copolymers obtained from monomers corresponding to the above general formula and those obtained using these monomers and other monomers, in particular vinyl derivatives such as vinyl alcohols and copolymerizable amides such as acrylamide or methacrylamide, are also suitable for use. Mention may also be made of the copolymers obtained from alkyl vinyl ether and from maleic acid as well as those obtained from vinylstyrene and maleic acid, which are described in particular in the Kirk-Othmer encyclopedia “Encyclopedia of Chemical Technology”—Volume 18—3rd Edition—Wiley Interscience Publication—1982.

The preferred polyelectrolytes have a low degree of polymerization. The weight-average molecular mass of the polyelectrolytes is more particularly less than 20,000 g/mol. Preferably, it is between 1,000 and 5,000 g/mol.

An ampholytic polymer is a polymer which comprises anionic or potentially anionic charges depending on the pH and cationic or potentially cationic charges depending on the pH, the potentially anionic or potentially cationic charges being taken into account for calculating the ratio of the total number of anionic charges to the total number of cationic charges.

The ampholytic film-forming polymer (AP) generally has a molecular mass of less than 500,000 g/mol, determined by aqueous gel permeation chromatography (GPC).

The ampholytic film-forming polymer (AP) may be obtained from anionic and cationic ethylenically unsaturated monomers. It may also be obtained from a mixture of monomers further containing neutral monomers. The anionic ethylenically unsaturated monomers may be chosen from acrylic, methacrylic, fumaric, maleic and itaconic acids or anhydrides, N-methacroylalanine, N-acryloylhydroxyglycine, and the like, or water-soluble salts thereof; sulfonated or phosphonated water-soluble ethylenically unsaturated monomers such as sulfopropyl acrylate and water-soluble salts thereof, water-soluble styrene sulfonates, vinylsulfonic acid and water-soluble salts thereof or vinylphosphonic acid and water-soluble salts thereof.

The cationic ethylenically unsaturated monomers may be chosen from

aminoacryloyl or acryloyloxy monomers such as trimethylaminopropyl methacrylate chloride, trimethylaminoethyl acrylamide or methacrylamide chloride or bromide, trimethylaminobutyl acrylamide or methacrylamide methyl sulfate, trimethylaminopropyl methacrylamide methyl sulfate (MES), (3-methacrylamidopropyl)trimethylammonium chloride (MAPTAC), (3-acrylamidopropyl)trimethylammonium chloride (APTAC), methacryloyloxyethyltrimethylammonium chloride or methyl sulfate, acryloyloxyethyltrimethylammonium chloride;

1-ethyl-2-vinylpyridinium bromide, chloride or methyl sulfate;

N,N-dialkyldiallylamine monomers such as N,N-dimethyldiallylammonium chloride (DADMAC);

polyquaternary monomers such as dimethylaminopropyl methacrylamide chloride, N-(3-chloro-2-hydroxypropyl)-trimethylammonium (DIQUAT), and the like.

The ethylenically unsaturated neutral monomers may be chosen from acrylamide, N-isopropylacrylamide, N,N-dimethylacrylamide, dimethylaminoethyl methacrylate (DMAEMA), dimethylaminopropyl methacrylamide, vinyl alcohol, alkyl or hydroxyalkyl acrylates or methacrylates, polyoxyalkylene glycol acrylates or methacrylates, and the like.

Mention may also be made most particularly, as ampholytic polymer (AP), of the copolymers or terpolymers

MAPTAC/acrylic or methacrylic acid; DIQUAT/acrylic or methacrylic acid; DADMAC/acrylic or methacrylic acid;

MES/acrylic or methacrylic acid/DMAEMA;

MAPTAC/acrylic acid/acrylamide; MAPTAC/maleic anhydride/acrylamide; MAPTAC/vinylsulfonic acid/acrylamide;

DADMAC/acrylic acid/acrylamide; DADMAC/maleic anhydride/acrylamide; DADMAC/vinylsulfonic acid/acrylamide;

DIQUAT/acrylic acid/acrylamide; DIQUAT/maleic anhydride/acrylamide; DIQUAT/vinylsulfonic acid/acrylamide;

with a ratio of the total number of anionic charges to the total number of cationic charges which may range from 0.1 to 10.

Among the monosaccharides (O) which may be mentioned are aldoses such as glucose, mannose, galactose and ribose, and ketoses such as fructose.

Saccharides are compounds which result from the condensation, with elimination of water, of monosaccharide molecules with each other or of monosaccharide molecules with non-carbohydrate molecules. Among the preferred saccharides are saccharides which are formed by combining exclusively carbohydrate units and more particularly oligosaccharides which comprise only a limited number of these units, i.e. a number generally less than or equal to 10. Examples of oligosaccharides which may be mentioned are sucrose, lactose, cellobiose, maltose and trehalose.

The water-soluble or water-dispersible polysaccharides are highly depolymerized; they are described, for example, in the book by P. Arnaud entitled “Cours de Chimie Organique”, edited by Gaultier-Villars, 1987. These polysaccharides more particularly have a weight-average molecular mass of less than 500,000 g/mol, preferably of less than 20,000 g/mol.

Nonlimiting examples of polysaccharides which may be mentioned are celluloses and cellulose derivatives (carboxymethyl cellulose), carrageenans; among the highly depolymerized polysaccharides, mention may be made of dextran, starch, xanthan gum and galactomannans such as guar or carob, these polysaccharides preferably having a melting point of greater than 100° C. and a solubility in water of between 5 g/l and 500 g/l.

Among the amino acids (AA) which may be mentioned are monocarboxylic or dicarboxylic monoamino acids, monocarboxylic diamino acids and water-soluble derivatives thereof.

The amino acids (AA) preferably have a side chain with acid-base properties; they are chosen in particular from arginine, lysine, histidine, aspartic acid, glutamic acid and hydroxyglutamic acid; they can also be in the form of derivatives, preferably water-soluble derivatives; they can be, for example, sodium, potassium or ammonium salts, such as sodium glutamate, aspartate or hydroxyglutamate.

As regards the surfactants (TA) which can constitute the matrix (M), the description of the fluid isotropic phase and rigid liquid crystal phase of hexagonal or cubic type is given in the book by R. G. Laughlin entitled “The Aqueous Phase Behavior of Surfactants”—Academic Press—1994. Their identification by radiation (X-ray and neutrons) scattering is described in the book by V. Luzzati entitled “Biological Membranes, Physical Fact and Function”—Academic Press—1968.

The rigid liquid crystal phase is more particularly stable up to a temperature at least equal to 55° C. The fluid isotropic phase can be cast, while the rigid liquid crystal phase cannot be.

Among the surfactants (TA) which may be mentioned are ionic glycolipid surfactants, in particular uronic acid derivatives (galacturonic acid, glucuronic acid, D-mannuronic acid, L-iduronic acid, L-guluronic acid, etc.), containing a substituted or unsubstituted, saturated or unsaturated hydrocarbon-based chain containing from 6 to 24 carbon atoms and preferably from 8 to 16 carbon atoms, or salts thereof. Products of this type are described in particular in patent application EP 532 370.

Other examples of surfactants (TA) are amphoteric surfactants such as amphoteric derivatives of alkyl polyamines such as Amphionic XL® and Mirataine H2C-HA® sold by Rhône-Poulenc, as well as Ampholac 7T/X® and Ampholac 7C/X® sold by Berol Nobel.

Among the alkali metal or alkaline-earth metal silicates (Sil), mention may be made in particular of those having an SiO₂/M₂O molar ratio of 1.6 to 3.5 with M representing a sodium or potassium atom.

Among the alkali metal or alkaline-earth metal phosphates (Phos), mention may be made in particular of sodium hexametaphosphate.

The preformulated additive according to the invention comprises, in addition, at the matrix (M)/polymer (P) interface, at least one nonionic, anionic, cationic or amphoteric surfactant (S).

Among the nonionic surfactants which may be mentioned in particular are polyoxyalkylenated derivatives such as

ethoxylated or ethoxy-propoxylated fatty alcohols

ethoxylated or ethoxy-propoxylated triglycerides

ethoxylated or ethoxy-propoxylated fatty acids

ethoxylated or ethoxy-propoxylated sorbitan esters

ethoxylated or ethoxy-propoxylated fatty amines

ethoxylated or ethoxy-propoxylated di(1-phenylethyl)phenols

ethoxylated or ethoxy-propoxylated tri(1-phenylethyl)phenols

ethoxylated or ethoxy-propoxylated alkylphenols.

The number of oxyethylene (OE) and/or oxypropylene (OP) units in these nonionic surfactants usually ranges from 2 to 100 depending on the desired HLB (hydrophilic/lipophilic balance). The number of OE and/or OP units is more particularly between 5 and 50.

The ethoxylated or ethoxy-propoxylated fatty alcohols generally comprise from 6 to 22 carbon atoms, the OE and OP units being excluded from these numbers. These units are preferably ethoxylated units.

The ethoxylated or ethoxy-propoxylated triglycerides can be triglycerides of plant or animal origin (such as lard, tallow, groundnut oil, butter oil, cottonseed oil, flax oil, olive oil, fish oil, palm oil, grapeseed oil, soybean oil, castor oil, rapeseed oil, copra oil or coconut oil and are preferably ethoxylated.

The ethoxylated or ethoxy-propoxylated fatty acids are esters of fatty acids (such as, for example, oleic acid or stearic acid), and are preferably ethoxylated.

The ethoxylated or ethoxy-propoxylated sorbitan esters are cyclized sorbitol esters of fatty acid comprising from 10 to 20 carbon atoms such as lauric acid, stearic acid or oleic acid, and are preferably ethoxylated.

In the present invention, the term “ethoxylated triglyceride” targets not only the products obtained by ethoxylation of a triglyceride with ethylene oxide but also those obtained by transesterification of a triglyceride with a polyethylene glycol.

Similarly, the term “ethoxylated fatty acid” includes not only the products obtained not ethoxylation of a fatty acid with ethylene oxide but also those obtained by transesterification of a fatty acid with a polyethylene glycol.

The ethoxylated or ethoxy-propoxylated fatty amines generally contain from 10 to 22 carbon atoms, the OE and OP units being excluded from these numbers, and are preferably ethoxylated.

The ethoxylated or ethoxy-propoxylated alkyl phenols are generally 1 or 2 linear or branched alkyl groups containing 4 to 12 carbon atoms. Examples which may be mentioned in particular are octyl, nonyl or dodecyl groups.

Among the anionic surfactants which may be mentioned are water-soluble salts of alkyl sulfates and of alkyl ether sulfates, alkyl isethionates and alkyl taurates or salts thereof, alkyl carboxylates, alkyl sulfosuccinates or alkyl succinamates, alkyl sarcosinates, alkyl derivatives of protein hydrolyzates, acyl aspartates, and alkyl and/or alkyl ether and/or alkylaryl ether phosphate esters.

The cation is generally an alkali metal or alkaline-earth metal, such as sodium, potassium, lithium or magnesium, or an ammonium group NR₄⁺ with R, which may be identical or different, representing an alkyl radical substituted or unsubstituted with an oxygen or nitrogen atom.

Among the amphoteric surfactants which may be mentioned are alkylbetaines, alkyldimethylbetaines, alkylamidopropylbetaines, alkylamidopropyldimethylbetaines, alkyltrimethylsulfobetaines, imidazoline derivatives such as alkyl amphoacetates, alkyl amphodiacetates, alkyl amphopropionates, alkyl amphodipropionates, alkylsultaines or alkylamidopropylhydroxysultaines, the condensation products of fatty acids and of protein hydrolyzates, amphoteric derivatives of alkylpolyamines such as Amphionic XL® sold by Rhône-Poulenc, Ampholac 7T/X® and Ampholac 7C/X® sold by Berol Nobel, and proteins or protein hydrolyzates.

Among the cationic surfactants, mention may be made in particular of the alkylammonium salts of formula

R^{1′}R^{2′}R^{3′}R^{4′}N³⁰X³¹

where

R^{1′} and R^{2′}, which are similar or different, represent a C₁-C₂₀ alkyl group, or an aryl or benzyl group,

R^{3′} and R⁴, which are similar or different, represent a C₁-C₂₀ alkyl group, or an aryl of benzyl group, or an ethylene oxide and/or propylene oxide condensate which may contain up to 30 oxyalkylene units, and

X⁻ is a solubilizing anion such as a halide (for example chloride, bromide, iodide), sulfate or methyl sulfate.

Mention may be made in particular of cetyltrimethylammonium bromide, Rhodaquat® TFR marketed by Rhodia.

Said surfactant (S) may be similar to the surfactant (TA).

The preformulated additive according to the invention is preferably provided in solid form with a dry appearance, for example in the form of a powder or of granules with a dry appearance.

Said preformulated additive may be obtained

by adding the water-soluble or water-dispersible compound(s) capable of forming the matrix (M) to a nanolatex of polymer (P) in the presence of at least one surfactant (S);

and then removing the water/drying the aqueous dispersion obtained.

The expression nanolatex of polymer means a stable aqueous dispersion of solid nanoparticles of polymer having a mean size of the order of 10 to 500 nm, preferably preferably 20 to 300 nm, most particularly 10 to 200 nm, still more particularly 20 to 50 nm.

Such a dispersion generally has a dry extract of the order of 10 to 50% by weight, preferably of the order of 20 to 40% by weight.

The particles of polymer (P) of the nanolatex have, at their surface, at least one emulsifier (or surfactant (S)) whose quantity depends on the size of the nanolatex particles.

Said nanolatex may be optionally diluted before use.

The respective quantities of nanolatex of polymer (P), of surfactant (S) and of water-soluble or water-dispersible compound(s) capable of forming the matrix (M) are such that the dispersion obtained contains, expressed on a dry basis,

from 5 to 90% by weight, preferably from 10 to 60% by weight of polymer (P)

from 3 to 90%, preferably from 10 to 80%, most particularly from 15 to 70% of water-soluble or water-dispersible compound(s) capable of forming the matrix (M)

and from 0.01 to 20%, preferably from 0.02 to 5% by weight of surfactant (S).

The dry extract of the dispersion obtained may be of the order of 5 to 60%, preferably of the order of 10 to 50%.

The operation of removing water/drying the aqueous dispersion of nanoparticles of polymer (P) and of a compound capable of forming the matrix (M) may be carried out according to any means known to a person skilled in the art, in particular by freeze-drying (that is to say freezing, following by sublimation) or preferably by spray-drying.

The spray-drying may be carried out in any known apparatus, such as a spray-drying tower combining a spraying carried out using a nozzle or a turbine with a hot air stream. The implementation conditions depend on the type of compound capable of forming the matrix (M) and on the spray-dryer used; these conditions are generally such that the temperature of the whole of the product during drying is at least 30° C. and does not exceed 150° C.

Methods of preparing pulverulent compositions of insoluble polymers which are dispersible in aqueous medium have already been described by the applicant.

Mention may be made in particular of

WO 96/17891: drying of a dispersion comprising a non-water-soluble polymer latex, a polysaccharide (lactose) and a compound chosen from alkylaromatic ionic compounds and polyvinylpyrrolidones;

WO 97/15617: drying of a dispersion comprising a non-water-soluble polymer latex, a surfactant of the amphoteric (amphoteric derivatives of alkylpolyamines) or ionic (uronic) glycolipic type, and an inorganic (silicates, phosphates) or organic (urea, sugars, polyelectrolytes) water-soluble compound;

WO 97/15616: drying of a dispersion comprising a non-water-soluble polymer latex, a polyoxyalkylenated nonionic surfactant and a polyelectrolyte (weak polyacid);

WO 97/25371: drying of a dispersion comprising a non-water-soluble polymer latex and an amino acid.

The techniques described by the applicant for the preparation of water-dispersible granules of hydrophobic active substances in solid or liquid form may also be used.

Mention may be made in particular of:

WO 99/38611: relating to water-dispersible granules comprising a hydrophobic active substance, a polypeptide (soybean protein) and an ionic or amphoteric dispersing agent.

Said preformulated additive of the invention may optionally contain, in addition, other adjuvants such as anticaking agents or fillers, such as in particular calcium carbonate, sodium sulfate, a clay such as bentonite or laponite, kaolin, silica, and the like, which may be fully or partially added either to the aqueous dispersion before removing the water, or during the spray-drying step or alternatively after drying.

According to a variant embodiment of the invention, said preformulated additive may, in addition, comprise, in the encapsulated state in the nanoparticles of polymer (P), at least one hydrophobic active material (AM).

Among these hydrophobic active materials, mention may be made of those present in the compositions for the treatment of textile fiber articles, in particular the hydrophobic detergent active materials.

All the active materials, whether they are solid or liquid (as they are or in solution in a solvent), are suitable since they are not miscible or are only very slightly miscible with water.

The expression slightly miscible means active materials whose solubility in water at pH 7 does not exceed 20% by weight, preferably 10% by weight.

As examples of active materials (AM), mention may be made of hydrophobic detergent active materials, such as for example perfumes, bleaching catalysts, biocidal agents, bleaching activators, anti-UV agents, optical brighteners, antioxidants, silicones.

The quantity of active material (AM) which may be present may range from 20 to 70, preferably from 40 to 60 parts by weight of active material (AM) per 100 parts by weight of polymer (P).

The encapsulation of the hydrophobic active material (AM) by the nanoparticles of polymer (P) may be carried out by introducing said active material (AM) into said nanoparticles of polymer (P) existing in the form of a nanolatex, it being possible to introduce the active material (AM) either during the actual synthesis of said polymer by polymerization in aqueous emulsion, or after synthesis of said polymer by polymerization in aqueous emulsion.

Preferably, the introduction of the active material (AM) into the nanolatex of polymer (P) is carried out after the step of polymerization in aqueous emulsion of the monomer composition.

The active material (AM) present in the liquid state may be introduced directly into the nanolatex of polymer (P) if it “swells” the polymer sufficiently, or aided, if necessary, by a swelling “transfer” solvent for the polymer.

Among the transfer solvents which may be mentioned are

esters such as ethyl acetate, methyl propionate, a mixture of methyl glutarate/adipate/succinate (“RPDE” solvent), etc.,

ketones such as methyl ethyl ketone, cyclohexanone, etc.,

alcohols such as propanol, pentanol, cyclohexanol, etc.,

aliphatic and cyclic hydrocarbons such as heptane, decane, cyclohexane, decalin, etc.,

chlorinated aliphatic derivatives such as dichloromethane, etc.,

aromatic derivatives such as toluene, ethylbenzene, etc.,

chlorinated aromatic derivatives such as trichlorobenzene, etc.,

dialkyl ethers.

The active material (AM) introduced is placed in contact with the nanolatex with stirring at a temperature of 20 to 50° C. for 1 to 24 hours.

Said “transfer” solvent can optionally be removed by evaporation under vacuum if the active material (AM) is a solid.

The compound(s) capable of forming the matrix (M) are then added to the nanolatex of polymer encapsulating the active material.

The dispersion obtained is then dried or gelled as described above.

Said preformulated additive which is the subject of the invention may be used for the preparation of a treatment composition for the care of textile fiber articles in an aqueous or wet medium. Said additive may be used in said compositions as a care agent, protecting the fibers from the phenomena of physical or chemical degradation and/or giving them advantages such as softening and/or crease-resistance properties; said additive is most particularly efficient as crease-resistance agent.

A second subject of the invention therefore consists in the use, in a composition for the treatment of textile fiber articles in an aqueous or wet medium, of said preformulated additive, as care agent, in particular as crease-resistance agent for said articles.

A third subject of the invention consists of a composition for the care of textile fiber articles comprising said preformulated additive.

The form of the composition and the conditions for use (or for treatment) may be many.

Said composition may be provided

in the form of a solid (powder, granules, tablets and the like) or of a concentrated nonaqueous dispersion, placed in contact with the articles to be treated, after dilution in water;

in the form of a solid support (textile support or stick) comprising said additive, placed in contact directly with the articles to be treated in the dry or wet state.

Thus, the composition of the invention may be:

a solid detergent formulation capable of directly forming, upon dilution, a washing bath;

a nonaqueous liquid detergent formulation capable of directly forming, upon dilution, a washing bath;

a rinsing and/or softening formulation capable of directly forming, upon dilution, a rinsing and/or softening bath;

a solid, in particular textile, material comprising the additive of the invention intended to be placed in contact with wet fabrics in a tumble dryer (said solid material is called hereinafter “drying additive”);

a “washing additive” (“prespotter”) intended to be deposited on dry fabrics prior to a washing operation using a detergent formulation containing or not containing the preformulated additive according to the invention.

The composition of the invention is particularly well suited to the care of textile fiber articles, in particular based on cotton, in particular containing at least 35% cotton.

The working pH for the composition of the invention may range from about 2 to about 12, depending on the desired use.

When it is

a detergent formulation, the pH of the washing bath is generally from about 7 to 11 and preferably from 8 to 10.5;

a rinsing and/or softening formulation, the pH of the rinsing and/or softening bath is generally from about 2 to 8;

a tumble dryer additive, the pH to be considered is that of the residual water, which may be from about 2 to 9;

a prespotter, the pH to be considered is that of the washing bath for the operation following the washing, namely from about 7 to 11 and preferably from 8 to 10.5.

For good implementation of the invention, at least 70% of the total mass of the polymer (P) of the preformulated additive is formed from hydrophobic unit(s) (N).

When hydrophilic units (F) are present, they preferably represent not more than 30% of the total mass of the polymer (P).

When crosslinking units (R) are present, they generally represent not more than 20%, preferably not more than 10% and most particularly not more than 5% of the total mass of the polymer (P).

A first type of composition of the invention consists of a composition (C1) comprising a preformulated additive in which the polymer (P1) is an uncharged or nonionizable polymer comprising

at least 70% of its weight of hydrophobic monomer units (N)

optionally at least 1% of its weight of uncharged or non-ionizable hydrophilic monomer units (F4)

optionally not more than 20% of its weight of uncharged or non-ionizable crosslinking units (R).

Preferably, said uncharged or non-ionizable polymer (P1) comprises:

at least 70% of its weight of hydrophobic monomer units (N)

from 3% to 30% of its weight of uncharged or non-ionizable hydrophilic monomer units (F4)

optionally not more than 20% and preferably not more than 10% of its weight of uncharged or non-ionizable crosslinking units (R).

The preformulated additive comprising said uncharged or non-ionizable polymer (P1) may be used in any type of textile fiber article care composition mentioned above, the working pH of which may range from 2 to 12, namely detergent formulations, rinsing and/or softening formulations, tumble dryer additives, or prespotters.

A second type of composition of the invention consists of a composition (C2) comprising a preformulated additive in which the polymer (P2) is a polymer containing anionic or anionizable units and being free of cationic or cationizable units, comprising

at least 70% of its weight of hydrophobic monomer units (N)

at least 1% of its weight, preferably from 3% to 30% of its weight and most particularly from 1% to 20% of its weight, of anionic or anionizable hydrophilic monomer units (F3)

optionally not more than 29% of its weight of uncharged or non-ionizable hydrophilic monomer units (F4).

The preformulated additive comprising polymer (P2) can be used in the textile fiber article care compositions of non-cationic nature, namely detergent formulations, tumble dryer additives, or prespotters.

A third type of composition of the invention consists of a composition (C3) comprising a preformulated additive in which the polymer (P3) containing amphoteric units, comprising

at least 70% of its weight of hydrophobic monomer units (N)

at least 0.1% of its weight, preferably not more than 20% of its weight and most particularly not more than 10% of its weight, of amphoteric hydrophilic monomer units (F2)

optionally uncharged or non-ionizable hydrophilic monomer units (F4)

optionally cationic or cationizable hydrophilic monomer units (F1), the combination of hydrophilic monomer units (F) preferably representing at least 1% of the weight of the polymer (P3), and the molar ratio of the cationic charges to the anionic charges possibly ranging from 1/99 to 80/20 depending on the desired use of said composition (C3).

The preformulated additive comprising the polymer (P3) with a molar ratio of the cationic charges to the anionic charges ranging from 1/99 to 80/20 may be used in tumble dryer additives.

The preformulated additive comprising the polymer (P3) with a molar ratio of the cationic charges to the anionic charges ranging from 1/99 to 60/40 and preferably from 5/95 to 50/50 may also be used in detergent formulations and prespotters.

A fourth type of composition of the invention consists of a composition (C4) comprising a preformulated additive in which the polymer (P4) is a polymer containing both cationic or cationizable units and anionic or anionizable units, comprising

at least 70% of its weight of hydrophobic monomer units (N)

cationic or cationizable hydrophilic monomer units (F1)

anionic or anionizable hydrophilic monomer units (F3)

optionally amphoteric hydrophilic monomer units (F2)

optionally uncharged or non-ionizable hydrophilic monomer units (F4), the combination of hydrophilic monomer units (F) preferably representing at least 1% of the weight of the polymer (P4), and the molar ratio of the cationic charges to the anionic charges possibly ranging from 1/99 to 80/20 depending on the desired use of said composition (C4).

The additive comprising the polymer (P4) with a molar ratio of the cationic charges to the anionic charges ranging from 1/99 to 80/20 may be used in tumble dryer additives.

The additive comprising the polymer (P4) with a molar ratio of the cationic charges to the anionic charges ranging from 1/99 to 60/40 and preferably from 5/95 to 50/50 may also be used in detergent formulations and prespotters.

A fifth type of composition of the invention consists of a composition (C5) comprising a preformulated additive in which the polymer (P5) is a polymer containing cationic or cationizable units and being free of anionic or anionizable units, comprising

at least 70% of its weight of hydrophobic monomer units (N)

at least 1% of its weight, preferably from 3% to 30% of its weight and most particularly from 1% to 10% of its weight, of cationic or cationizable hydrophilic monomer units (F1)

optionally not more than 20% of its weight of uncharged or non-ionizable hydrophilic monomer units (F4).

The preformulated additive comprising the polymer (P5) may be used in any type of textile fiber article care composition mentioned above, the working pH of which may range from 2 to 12, namely detergent formulations, rinsing and/or softening formulations, tumble dryer additives, or prespotters.

In a most preferred manner, when the composition (C5) is a detergent composition, said monomer units (F1) are cationizable units derived from at least one cationizable monomer with a pKa of less than 11 and preferably of less than 10.5.

As examples of polymer (P), mention may be made in particular of copolymers containing units derived from

methyl methacrylate/butyl acrylate/hydroxyethyl methacrylate/methacrylic acid, the glass transition temperature Tg of which may range from 10° C. to 80° C., depending on the composition of said polymer

methyl methacrylate/ethylene glycol dimethacrylate/methacrylic acid, the glass transition temperature Tg of which may range from 10° C. to 80° C., depending on the composition of said polymer

styrene/divinylbenzene/methacrylic acid, the glass transition temperature Tg of which may range from 100° C. to 140° C., depending on the composition of said polymer

styrene/butyl acrylate/hydroxyethyl methacrylate/methacrylic acid, the glass transition temperature Tg of which may range from 10° C. to 80° C., depending on the composition of said polymer

Veova 10 (vinyl C₁₀ versatate)/methyl methacrylate/butyl acrylate/methacrylic acid, the glass transition temperature Tg of which may range from 10° C. to 80° C., depending on the composition of said polymer

methyl methacrylate/butyl acrylate/hydroxyethyl methacrylate/methacrylic acid/N,N-dimethyl-N-methacryloyloxyethyl-N-(3-sulfopropyl)ammonium sulfobetaine (SPE from Raschig), the glass transition temperature Tg of which may range from 10° C. to 80° C., depending on the composition of said polymer

methyl methacrylate/butyl acrylate/hydroxyethyl methacrylate/methacrylic acid/vinylphosphonic acid, the glass transition temperature Tg of which may range from 10° C. to 80° C., depending on the composition of said polymer

methyl methacrylate/butyl acrylate/hydroxyethyl methacrylate/methacrylic acid/Empicryl 6835 from Rhodia, the glass transition temperature Tg of which may range from 10° C. to 80° C., depending on the composition of said polymer

styrene/butadiene/acrylic acid, the glass transition temperature Tg of which may range from −40° C. to 10° C.

butyl acrylate/methacrylic acid, the glass transition temperature Tg of which may range from −40° C. to 10° C.

The amount of preformulated additive, expressed as dry weight of polymer (P), present in the care composition according to the invention may range from 0.05% to 10% as dry weight relative to the dry weight of said composition, depending on the desired application.

Thus, the preformulated additive may be used as follows:

| % of polymer (P) | In a care |
|---|---|
| (as dry weight) | composition used as |
| 0.05-5 | detergent formulation |
| preferably 0.1-3 | |
| 0.05-3 | rinsing and/or |
| preferably 0.1-2 | softening formulation |
| 0.05-10 | tumble dryer additive |
| preferably 0.1-5 | |
| 0.05-10 | prespotter |
| preferably 0.1-5 | |

Other constituents may be present, along with the preformulated additive, in the care composition according to the invention. The nature of these constituents depends on the desired use of said composition.

Thus, when it is a detergent formulation, for washing textile fiber articles, in particular fabrics, it generally comprises:

at least one natural and/or synthetic surfactant,

at least one detergent adjuvant (“builder”)

optionally an oxidizing agent or system, and

a series of specific additives.

The detergent formulation may comprise surfactants in an amount corresponding to about 3% to 40% by weight relative to the detergent formulation, these surfactants being such as

Anionic Surfactants

alkyl ester sulfonates of formula R—CH(SO₃M)—COOR′, in which R represents a C₈-C₂₀ and preferably C₁₀-C₆ alkyl radical, R′ represents a C₁-C₆ and preferably C₁-C₃ alkyl radical and M represents an alkali metal (sodium, potassium or lithium) cation, a substituted or unsubstituted ammonium (methyl-, dimethyl-, trimethyl- or tetramethylammonium, dimethylpiperidinium, etc.) or an alkanolamine derivative (monoethanolamine, diethanolamine, triethanolamine, etc.). Mention may be made most particularly of methyl ester sulfonates in which the radical R is C₁₄-C₁₆;

alkyl sulfates of formula ROSO₃M, in which R represents a C₅-C₂₄ and preferably C₁₀-C₁₈ alkyl or hydroxyalkyl radical, M representing a hydrogen atom or a cation of the same definition as above, and also the ethoxylenated (EO) and/or propoxylenated (PO) derivatives thereof, containing on average from 0.5 to 30 and preferably from 0.5 to 10 EO and/or PO units;

alkylamide sulfates of formula RCONHR′OSO₃M in which R represents a C₂-C₂₂ and preferably C₆-C₂₀ alkyl radical, R′ represents a C₂-C₃ alkyl radical, M representing a hydrogen atom or a cation of the same definition as above, and also the ethoxylenated (EO) and/or propoxylenated (PO) derivatives thereof, containing on average from 0.5 to 60 EO and/or PO units;

saturated or unsaturated C₈-C₂₄ and preferably C₁₄-C₂₀ fatty acid salts, C₉-C₂₀ alkylbenzenesulfonates, primary or secondary C₈-C₂₂ alkylsulfonates, alkylglyceryl sulfonates, the sulfonated polycarboxylic acids described in GB-A-1 082 179, paraffin sulfonates, N-acyl N-alkyltaurates, alkyl phosphates, isethionates, alkyl succinamates, alkyl sulfosuccinates, sulfosuccinate monoesters or diesters, N-acyl sarcosinates, alkylglycoside sulfates, polyethoxycarboxylates; the cation being an alkali metal (sodium, potassium or lithium), a substituted or unsubstituted ammonium residue (methyl-, dimethyl-, trimethyl- or tetramethylammonium, dimethylpiperidinium, etc.) or an alkanolamine derivative (monoethanolamine, diethanolamine, triethanolamine, etc.);

Nonionic Surfactants

polyoxyalkylenated (polyoxyethylenated, polyoxypropylenated or polyoxybutylenated) alkylphenols in which the alkyl substituent is C₆-C₁₂ and containing from 5 to 25 oxyalkylene units; examples which may be mentioned are the products Triton X-45, X-114, X-100 or X-102 sold by Rohm & Haas Co.;

glucosamide, glucamide or glycerolamide;

polyoxyalkylenated C₈-C₂₂ aliphatic alcohols containing from 1 to 25 oxyalkylene (oxyethylene or oxypropylene) units; examples which may be mentioned are the products Tergitol 15-S-9 and Tergitol 24-L-6 NMW sold by Union Carbide Corp., Neodol 45-9, Neodol 23-65, Neodol 45-7 and Neodol 45-4 sold by Shell Chemical Co., and Kyro EOB sold by The Procter & Gamble Co.;

products resulting from the condensation of ethylene oxide or the compound resulting from the condensation of propylene oxide with propylene glycol, such as the Pluronic products sold by BASF;

products resulting from the condensation of ethylene oxide or the compound resulting from the condensation of propylene oxide with ethylenediamine, such as the Tetronic products sold by BASF;

amine oxides such as C₁₀-C₁₈ alkyl dimethylamine oxides and C₈-C₂₂ alkoxy ethyl dihydroxyethylamine oxides;

the alkylpolyglycosides described in U.S. Pat. No. 4,565,647;

C₈-C₂₀ fatty acid amides;

ethoxylated fatty acids;

ethoxylated fatty amides;

ethoxylated amines.

Amphoteric and Zwitterionic Surfactants

alkyldimethylbetaines, alkylamidopropyldimethylbetaines, alkyltrimethylsulfobetaines and the products of condensation of fatty acids and of protein hydrolysates;

alkyl amphoacetates or alkyl amphodiacetates in which the alkyl group contains from 6 to 20 carbon atoms.

The detergent adjuvants (“builders”) for improving the surfactant properties may be used in amounts corresponding to about 5-50% and preferably to about 5-30% by weight for the liquid detergent formulations or to about 10-80% and preferably 15-50% by weight for the powder detergent formulations, these detergent adjuvants being such as:

Mineral Detergent Adjuvants

polyphosphates (tripolyphosphates, pyrophosphates, orthophosphates or hexametaphosphates) of alkali metals, of ammonium or of alkanolamines

tetraborates or borate precursors;

silicates, in particular those with an SiO₂/Na₂O ratio from about 1.6/1 to 3.2/1 and the lamellar silicates described in U.S. Pat. No. 4,664,839;

alkali metal or alkaline-earth metal carbonates (bicarbonates, sesquicarbonates);

cogranulates of alkali metal silicate hydrates and of alkali metal (sodium or potassium) carbonates that are rich in silicon atoms in Q2 or Q3 form, described in EP-A-488 868;

crystalline or amorphous aluminosilicates of alkali metals (sodium or potassium) or of ammonium, such as zeolites A, P, X, etc.; zeolite A with a particle size of about 0.1-10 micrometers is preferred.

Organic Detergent Adjuvants

water-soluble polyphosphonates (ethane 1-hydroxy-1,1-diphosphonates, methylenediphosphonate salts, etc.);

water-soluble salts of carboxylic polymers or copolymers or water-soluble salts thereof, such as:

polycarboxylate ethers (oxydisuccinic acid and its salts, monosuccinic acid tartrate and its salts, disuccinic acid tartrate and its salts);

hydroxypolycarboxylate ethers;

citric acid and its salts, mellitic acid and succinic acid and their salts;

polyacetic acid salts (ethylenediaminetetraacetates, nitrilotriacetates, N-(2-hydroxyethyl)nitrilodiacetates);

C₅-C₂₀ alkyl succinic acids and their salts (2-dodecenylsuccinates, lauryl succinates);

carboxylic polyacetal esters;

polyaspartic acid and polyglutamic acid and their salts;

polyimides derived from the polycondensation of aspartic acid and/or of glutamic acid;

polycarboxymethyl derivatives of glutamic acid or of other amino acids.

The detergent formulation may also comprise at least one oxygen-releasing bleaching agent comprising a percompound, preferably a persalt.

Said bleaching agent may be present in an amount corresponding to about 1% to 30% and preferably from 4% to 20% by weight relative to the detergent formulation.

As examples of percompounds which may be used as bleaching agents, mention should be made in particular of perborates such as sodium perborate monohydrate or tetrahydrate; peroxygenated compounds such as sodium carbonate peroxyhydrate, pyrophosphate peroxyhydrate, urea peroxyhydrate, sodium peroxide and sodium persulfate.

The preferred bleaching agents are sodium perborate monohydrate or tetrahydrate and/or sodium carbonate peroxyhydrate.

Said agents are generally combined with a bleaching activator which generates, in situ in the washing medium, a peroxycarboxylic acid in an amount corresponding to about 0.1% to 12% and preferably from 0.5% to 8% by weight relative to the detergent formulation. Among these activators, mention may be made of tetraacetylethylenediamine, tetraacetylmethylenediamine, tetraacetylglycoluryl, sodium p-acetoxybenzenesulfonate, pentaacetylglucose and octaacetyllactose.

Mention may also be made of non-oxygenated bleaching agents, which act by photoactivation in the presence of oxygen, these being agents such as sulfonated aluminum and/or zinc phthalocyanins.

The detergent formulation may also comprise soil-release agents, anti-redeposition agents, chelating agents, dispersants, fluorescers, foam suppressants, softeners, enzymes and various other additives.

Soil-release Agents

These may be used in amounts of about 0.01-10%, preferably about 0.1-5% and more preferably about 0.2-3% by weight.

Mention may be made more particularly of agents such as:

cellulose derivatives such as cellulose hydroxy ethers, methylcellulose, ethylcellulose, hydroxypropylmethylcellulose or hydroxybutylmethylcellulose;

polyvinyl esters grafted onto polyalkylene trunks, such as polyvinyl acetates grafted onto polyoxyethylene trunks (EP-A-219 048);

polyvinyl alcohols;

polyester copolymers based on ethylene terephthalate and/or propylene terephthalate and polyoxyethylene terephthalate units, with an ethylene terephthalate and/or propylene terephthalate (number of units)/polyoxyethylene terephthalate (number of units) molar ratio from about 1/10 to 10/1 and preferably from about 1/1 to 9/1, the polyoxyethylene terephthalates containing polyoxyethylene units with a molecular weight from about 300 to 5,000 and preferably from about 600 to 5,000 (U.S. Pat. No. 3,959,230, U.S. Pat. No. 3,893,929, U.S. Pat. No. 4,116,896, U.S. Pat. No. 4,702,857, U.S. Pat. No. 4,770,666);

sulfonated polyester oligomers obtained by sulfonation of an oligomer derived from ethoxylated allylic alcohol, from dimethyl terephthalate and from 1,2-propylene diol, containing from 1 to 4 sulfonated groups (U.S. Pat. No. 4,968,451);

polyester copolymers based on propylene terephthalate and polyoxyethylene terephthalate units and ending with ethyl or methyl units (U.S. Pat. No. 4,711,730) or polyester oligomers ending with alkylpolyethoxy groups (U.S. Pat. No. 4,702,857) or sulfopolyethoxy (U.S. Pat. No. 4,721,580) or sulfoaroyl (U.S. Pat. No. 4,877,896) anionic groups;

sulfonated polyester copolymers derived from terephthalic, isophthalic and sulfoisophthalic acid, anhydride or diester and from a diol (FR-A-2 720 399).

Anti-redeposition Agents

These may be used in amounts generally of about 0.01-10% by weight for a powder detergent formulation or about 0.01-5% by weight for a liquid detergent formulation.

Mention may be made in particular of agents such as:

ethoxylated monoamines or polyamines, and ethoxylated amine polymers (U.S. Pat. No. 4,597,898, EP-A-11 984);

carboxymethylcellulose;

sulfonated polyester oligomers obtained by condensation of isophthalic acid, dimethyl sulfosuccinate and diethylene glycol (FR-A-2 236 926);

polyvinylpyrrolidones.

Chelating Agents

Agents for chelating iron and magnesium may be present in amounts of about 0.1-10% and preferably of about 0.1-3% by weight.

Mention may be made, inter alia, of:

aminocarboxylates such as ethylenediaminetetraacetates, hydroxyethylethylenediaminetriacetates and nitrilotriacetates;

aminophosphonates such as nitrilotris(methylenephosphonates);

polyfunctional aromatic compounds such as dihydroxydisulfobenzenes.

Polymeric Dispersants

These may be present in an amount of about 0.1-7% by weight, to control the calcium and magnesium hardness, these being agents such as:

water-soluble polycarboxylic acid salts with a molecular mass from about 2,000 to 100,000, obtained by polymerization or copolymerization of ethylenically unsaturated carboxylic acids such as acrylic acid, maleic acid or anhydride, fumaric acid, itaconic acid, aconitic acid, mesaconic acid, citraconic acid or methylenemalonic acid, and most particularly polyacrylates with a molecular mass from about 2,000 to 10,000 (U.S. Pat. No. 3,308,067), copolymers of acrylic acid and of maleic anhydride with a molecular mass from about 5,000 to 75,000 (EP-A-66 915);

polyethylene glycols with a molecular mass from about 1,000 to 50,000.

Fluorescers (Brighteners)

These may be present in an amount of about 0.05-1.2% by weight, these being agents such as:

stilbene, pyrazoline, coumarin, fumaric acid, cinnamic acid, azole, methinecyanin, thiophene, etc. derivatives (“The production and application of fluorescent brightening agents”—M. Zahradnik, published by John Wiley & Sons, New York, 1982).

Foam Suppressants

These may be present in amounts which may be up to 5% by weight, these being agents such as:

C₁₀-C₂₄ monocarboxylic fatty acids or alkali metal, ammonium or alkanolamine salts thereof, and fatty acid triglycerides;

saturated or unsaturated aliphatic, alicyclic, aromatic or heterocyclic hydrocarbons, such as paraffins and waxes;

N-alkylaminotriazines;

monostearyl phosphates and monostearyl alkyl phosphates;

polyorganosiloxane oils or resins optionally combined with silica particles.

Softeners

These may be present in amounts of about 0.5-10% by weight, these being agents such as clays.

Enzymes

These may be present in an amount which may be up to 5 mg by weight and preferably of about 0.05-3 mg of active enzyme/g of detergent formulation, these being enzymes such as:

proteases, amylases, lipases, cellulases and peroxidases (U.S. Pat. No. 3,553,139, U.S. Pat. No. 4,101,457, U.S. Pat. No. 4,507,219, U.S. Pat. No. 4,261,868).

Other Additives

Mention may be made, inter alia, of:

buffers,

fragrances,

pigments.

The detergent formulation may be used, in particular in a washing machine, in a proportion of from 0.5 g/l to 20 g/l and preferably from 2 g/l to 10 g/l to carry out washing operations at a temperature from about 25 to 90° C.

The preformulated additive according to the invention may be present in a formulation for rinsing and/or softening textile fiber articles, in particular fabrics.

Along with the preformulated additive comprisng the polymer (P), there may be present other constituents of the type such as:

combinations of cationic surfactants (triethanolamine diester quaternized with dimethyl sulfate, N-methylimidazoline tallow ester methyl sulfate, dialkyldimethylammonium chloride, alkylbenzyldimethylammonium chloride, methyl alkylimidazolinium sulfate, methyl and methylbis(alkylamidoethyl)-2-hydroxyethylammonium sulfate, etc.) in an amount which may range from 3% to 50% and preferably from 4% to 30% of said formulation, optionally combined with nonionic surfactants (ethoxylated fatty alcohols, ethoxylated alkylphenols, etc.) in an amount which may be up to 3%;

optical brighteners (0.1% to 0.2%);

optionally, colorfast agents (polyvinylpyrrolidone, polyvinyloxazolidone, polymethacrylamide, etc. 0.03% to 25% and preferably 0.1% to 15%),

colorants,

fragrances,

solvents, in particular alcohols (methanol, ethanol, propanol, isopropanol, ethylene glycol or glycerol),

foam limiters.

In the case of a fabric drying additive in an appropriate tumble dryer, it comprises a flexible solid support consisting, for example, of a strip of woven or nonwoven textile or a sheet of cellulose, comprising said preformulated additive comprising the polymer (P); said tumble dryer additive is introduced at the time of tumble drying into the wet fabrics to be dried at a temperature of the order of 50 to 80° C. for 10 to 60 minutes.

Said tumble dryer additive may also comprise cationic softeners (up to 99%) and colorfast agents (up to 80%), such as those mentioned above.

In the case of a prespotter, it may be in the form of a solid (stick).

Along with the preformulated additive comprising the polymer (P), there may be present other constituents of the type such as:

anionic surfactants such as those already mentioned above, in an amount of at least 5% of the weight of the composition

nonionic surfactants such as those already mentioned above, in an amount which may range from 15% to 40% of the weight of the composition

aliphatic hydrocarbons, in an amount which may range from 5% to 20% of the weight of the composition.

A final subject of the invention consists of a method of caring for textile fiber articles by treating said articles with a composition, in an aqueous or wet medium, comprising said preformulated additive. The type of composition, and the amounts of preformulated additive, expressed as polymer (P), and other additives which may be used, have already been mentioned above.

The following examples are given by way of illustration:

The nanolatex of polymer (P) used in the examples for the preparation of a preformulated additive in the form of a powder is an aqueous dispersion of methyl methacrylate/butyl acrylate/hydroxyethyl methacrylate/methacrylic acid copolymer, in a mass ratio between the various monomers of 37/55/5/3, the glass transition temperature Tg of which is of the order of 17° C., having a mean particle size of 35 nm (determination by light scattering using a Zetasizer apparatus from Malvern Instrument) and having a dry extract of the order of 30%. Said nanolatex was stabilized during its synthesis with 5% by weight, relative to the dry copolymer, of sodium dodecyl sulfate.

### EXAMPLE 1

A powdered preformulated additive is prepared as follows from said nanolatex of polymer (P) above, using

an aqueous solution of nonionic surfactant Synperonic A7 (ethoxylated fatty alcohol) from ICI

an aqueous solution of non-neutralized polyacrylic acid with a weight-average molar mass of 2,000 g/mol, containing 67% of active material (Bevaloid 6778 from Bevaloid).

Procedure:

an aqueous solution 1) containing 4% of Synperonic A7 is prepared by mixing 0.5 g of Synperonic A7 and 12 g of water;

a dispersion 2) containing 14.5% of active material is prepared by diluting 23 g of said nanolatex of polymer (P) in 24.5 g of water, with stirring;

solution 1) is then added little by little to dispersion 2) with stirring; the stirring is further maintained for 5 minutes after stopping the addition;

the aqueous polyacrylic acid solution is then added little by little to the preceding mixture, with stirring; the stirring is further maintained for 5 minutes after stopping the addition. 100 g of an aqueous dispersion are obtained which have:

0.5% of Synperonic A7

6.9% of dry polymer (P)

26.8% of dry polyacrylic acid

65.8% of deionized water.

The dispersion is then dried using a Niro Majeur spray-dryer (inlet air temperature=140° C.); a powder containing 26% of its weight of polymer (P) is obtained.

### EXAMPLE 2

A powdered preformulated additive is prepared as follows from said nanolatex of polymer (P) above, using sucrose as matrix; the quantity of sodium dodecyl sulfate obtained from the synthesis of said nanolatex of polymer (P) is sufficient to stabilize the dispersion.

Procedure:

50 g of commercial sucrose are added to 50 g of said nanolatex of polymer (P) containing 30% of dry extract stabilized with 5% of sodium dodecyl sulfate,

the dispersion obtained is dried in an oven at 50° C.; the residue obtained is then finely ground.

### EXAMPLE 3

Detergent formulation

| | Formulation | | |
|---|---|---|---|
| | | (B) | |
| | (A) | color | (C) |
| | with P | without P | without P |
| Constituents | % by weight | % by weight | % by weight |
| NaTPP | 40 | | |
| Zeolite 4A | 0 | 25 | 25 |
| 2 SiO₂, Na₂O silicate | 5 | 5 | 5 |
| Sodium carbonate | 5 | 15 | 15 |
| Acrylate/maleate copolymer | 0 | 5 | 5 |
| Sokalan CP5 (BASF) | | | |
| Sodium sulfate | 8 | 21 | 8 |
| CMC blanose 7MXF | 1 | 1 | 1 |
| (Hercules) | | | |
| Perborate monohydrate | 15 | 0 | 15 |
| Granulated TAED | 5 | 0 | 5 |
| Anionic surfactant | 6 | 8 | 6 |
| Laurylbenzene sulfate (Nansa) | | | |
| Nonionic surfactant | 3 | 5 | 3 |
| Symperonic A3 (3 EO | | | |
| ethoxylated alcohol—ICI) | | | |
| Nonionic surfactant | 9 | 11 | 9 |
| Symperonic A9 (9 EO | | | |
| ethoxylated alcohol—ICI) | | | |
| Enzymes (esperases, | 0.5 | 0.5 | 0.5 |
| amylases, cellulase, protease) | | | |
| Fragrances | 1 | 1 | 1 |
| Preformulated additive of | 1.0 | 1.0 | 1.0 |
| example 1 or 2 (% expressed | | | |
| as dry polymer P) | | | |
| Polyvinylpyrrolidone | 0 | 1 | 0 |
| Soil-release sulfonated | 0.5 | 0.5 | 0.5 |
| copolyester Repel-O-Tex | | | |
| PF 594 from Rhodia | | | |

A washing operation is carried out in a Tergotometer laboratory machine which is well known in the profession to detergent composition formulators. The machine simulates the mechanical and thermal effects of pulsating-type American washing machines, but, by virtue of the presence of 6 washing drums, it makes it possible to carry out simultaneous series of tests with an appreciable saving in time.

25×25 cm test pieces are cut from unfinished cotton. The cotton test pieces are first ironed so that they all have the same level of creasing before washing.

They are then washed using the above detergent formulation containing the preformulated additive prepared in example 1 or 2, and rinsed once, under the following conditions:

number of test pieces per Tergotometer drum: 2

volume of water: 1 liter

water of French hardness 30⁰TH obtained by suitable dilution of Contrexéville® brand mineral water

washing product concentration: 5 g/l

washing temperature: 40° C.

washing time: 20 min

spin speed of the Tergotometer: 100 rpm

rinsing with cold water (about 30⁰TH)

rinsing time: 5 minutes

The test pieces are then creased under a 3 kg press for 20 seconds, after which they are dried vertically overnight.

The same operation is carried out using the same detergent formulation, but free of preformulated additive.

A digital color photograph is then taken of the dry test pieces, which is then converted into 256 gray scale levels (gray scale from 0 to 255).

The number of pixels corresponding to each gray scale level are counted.

For each histogram obtained, the standard deviation σ of the distribution of the gray scale level is measured.

σ1 corresponds to the standard deviation obtained with the detergent formulation containing no preformulated additive.

σ2 corresponds to the standard deviation obtained with the detergent formulation containing preformulated additive.

The performance value is given by the equation −Δσ=σ2−σ1

The performance values obtained are as follows:

| Formulation | (A) | (B) | (C) |
|---|---|---|---|
| −Δσ | 3.5 | 4 | 4.5 |

These positive values of −Δσ are representative of a crease-resistance property provided by the detergent formulation comprising the preformulated additive according to the invention.

The matrix (M) has no impact on the crease-resistance properties of the preformulated additive.

1. Preformulated additive for a composition for treating textile fiber articles in aqueous or wet medium, characterized:
in that it comprises:
at least one particulate solid organic polymer (P) dispersed in and/or encapsulated by a matrix (M) made of at least one organic or inorganic compound
and at least one surfactant (S) at the matrix (M)/polymer (P) interface
in that said matrix (M) is soluble or dispersible in said medium
and in that said polymer (P) is insoluble and capable of dispersing in said medium in the form of nanoparticles.

2. Preformulated additive according to claim 1, characterized in that it comprises, expressed on a dry basis:
from 5 to 90%, preferably from 10 to 60%, of its weight of polymer (P)
from 3-90%, preferably from 10 to 80%, most particularly from 15 to 75%, of its weight of matrix (M)
from 0.01 to 20%, preferably from 0.02 to 5%, by weight of surfactant (S).

3. Preformulated additive according to claim 1 or 2, characterized in that said polymer (P) has a glass transition temperature Tg of from −40° C. to 150° C., preferably of from −40° C. to 100° C., most particularly of from −40° C. to 40° C.

4. Preformulated additive according to any one of claims 1 to 3, characterized in that the nanoparticles of polymer (P) have a diameter of from 10 to 500 nm, preferably from 20 to 300 nm, most particularly from 20 to 100 nm, still more particularly from 20 to 50 nm.

5. Preformulated additive according to any one of claims 1 to 4, characterized in that the compounds capable of forming the matrix (M) are chosen from the following water-soluble or water-dispersible organic and inorganic compounds:
water-soluble or water-dispersible polypeptides (PP) of natural or synthetic origin
polyelectrolytes (PE) in acid form, belonging to the family of weak polyacids, having a molecular mass of less than 20,000 g/mol, preferably between 1,000 and 5,000 g/mol
polyethylene glycols (PEG) having a molecular mass of between 4,000 and 100,000 g/mol
polyvinylpyrrolidones (PVP) having a molecular mass of less than 20,000 g/mol, preferably between 1,000 and 10,000 g/mol
polyvinyl alcohols (PVA) having a molecular mass of less than 100,000 g/mol, and preferably having a deacetylation value of from 80 to 99 mol%, preferably from 87 to 95 mol%
water-soluble or water-dispersible film-forming ampholytic polymers (AP)
water-soluble or water-dispersible monosaccharides, saccharides or polysaccharides (O)
amino acids (AA) or water-soluble or water-dispersible salts of amino acids
urea
surfactants (TA) whose water-surfactant binary phase diagram comprises an isotropic phase which is fluid at 25° C. up to a concentration of at least 50% by weight of surfactant, followed by a rigid liquid crystal phase of the hexagonal or cubic type at higher concentrations, which is stable at least up to 60° C.
water-soluble or water-dispersible alkali metal or alkaline-earth metal silicates (Sil) and phosphates (Phos)
or mixtures thereof.

6. Preformulated additive according to any one of claims 1 to 5, characterized in that the surfactant at the matrix (M)/polymer (P) interface is nonionic, anionic, cationic or amphoteric.

7. Preformulated additive according to any one of claims 1 to 6, characterized in that said additive is provided in solid form with a dry appearance.

8. Preformulated additive according to claim 7, characterized in that said additive is in the form of a powder or of granules.

9. Preformulated additive according to any one of claims 1 to 8, characterized in that it can be obtained
by adding the water-soluble or water-dispersible compound(s) capable of forming the matrix (M) to a nanolatex of polymer (P) in the presence of at least one surfactant (S);
and then removing the water/drying the aqueous dispersion obtained.

10. Preformulated additive according to claim 9, characterized in that said nanolatex has a mean particle size of from 10 to 500 nm, preferably 20 to 300 nm, most particularly 10 to 200 nm, still more particularly 20 to 50 nm.

11. Preformulated additive according to claim 9 or 10, characterized in that the respective quantities of nanolatex of polymer (P), of surfactant (S) and of water-soluble or water-dispersible compound(s) capable of forming the matrix (M) are such that the dispersion obtained contains, expressed on a dry basis,
from 5 to 90% by weight, preferably from 10 to 60% by weight of polymer (P)
from 3 to 90%, preferably from 10 to 80%, most particularly from 15 to 70% of water-soluble or water-dispersible compound(s) capable of forming the matrix (M)
and from 0.01 to 20%, preferably from 0.02 to 5% by weight of surfactant (S),
the dry extract of said dispersion being from 5 to 60%, preferably from 10 to 50%.

12. Preformulated additive according to any one of claims 9 to 11, characterized in that the operation of removing water/drying the aqueous dispersion of nanoparticles of polymer (P) and of a compound capable of forming the matrix (M) is carried out by spray-drying.

13. Preformulated additive according to any one of claims 1 to 12, characterized in that said polymer (P) comprises:
hydrophobic monomer units (N) that are uncharged or non-ionizable at the working pH of the treatment composition,
optionally at least one hydrophilic monomer unit (F) chosen from monomer units
(F1) that are cationic or cationizable at the working pH of said composition,
(F2) that are amphoteric at the working pH of said composition,
(F3) that are anionic or anionizable at the working pH of said composition,
(F4) that are uncharged or non-ionizable, of hydrophilic nature, at the working pH of said composition,
or mixtures thereof
and optionally at least one crosslinking unit (R).

14. Preformulated additive according to claim 13, characterized in that said monomer units (N) and (F) are derived from α-β monoethylenically unsaturated monomers, and the optional monomer units (R) are derived from diethylenically unsaturated monomers.

15. Preformulated additive according to claim 13 or 14, characterized in that the hydrophobic units (N) are derived from vinylaromatic monomers, from alkyl esters of α-β monoethylenically unsaturated acids, from vinyl or allyl esters of saturated carboxylic acids, from α-β monoethylenically unsaturated nitrites or from α-olefins.

16. Preformulated additive according to any one of claims 13 to 15, characterized in that the cationic or cationizable hydrophilic units (F1) are derived from N,N-(dialkylamino-ω-alkyl)amides of α-β monoethylenically unsaturated carboxylic acids, from α-β monoethylenically unsaturated amino esters or from monomers that are precursors of primary amine functions by hydrolysis.

17. Preformulated additive according to any one of claims 13 to 16, characterized in that the amphoteric hydrophilic units (F2) are derived from N,N-dimethyl-N-methacryloyloxyethyl-N-(3-sulfopropyl)ammonium sulfobetaine, N,N-dimethyl-N-(2-methacrylamidoethyl)-N-(3-sulfopropyl)ammonium betaine, 1-vinyl-3-(3-sulfopropyl)imidazolidium betaine, 1-(3-sulfopropyl)-2-vinylpyridinium betaine, derivatives of the quaternization reaction of N-(dialkylamino-ω-alkyl)amides of α-β ethylenically unsaturated carboxylic acids, or ethylenically unsaturated amino esters, with a chloroacetate of alkali metal or of propane sultone.

18. Preformulated additive according to any one of claims 13 to 17, characterized in that the anionic or anionizable hydrophilic units (F3) are derived from α-β monoethylenically unsaturated monomers containing at least one carboxylic function, α-62 monoethylenically unsaturated monomers containing at least one sulfate or sulfonate function, α-β monoethylenically unsaturated monomers containing at least one phosphonate or phosphate function, and water-soluble salts thereof, or α-β monoethylenically unsaturated monomers that are precursors of carboxylate function(s) by hydrolysis.

19. Preformulated additive according to any one of claims 13 to 18, characterized in that the uncharged or non-ionizable hydrophilic units (F4) are derived from hydroxyalkyl esters of α-β ethylenically unsaturated acids, α-β ethylenically unsaturated acid amides, α-β ethylenically unsaturated monomers bearing a water-soluble polyoxyalkylenated segment, α-β ethylenically unsaturated monomers that are precursors of vinyl alcohol units or of polyvinyl alcohol segments by polymerization and then hydrolysis, or methacrylamidoethyl-2-imidazolidinone.

20. Preformulated additive according to any one of claims 13 to 19, characterized in that the crosslinking units (R) are derived from divinylbenzene, ethylene glycol dimethacrylate, allyl methacrylate, methylene bis(acrylamide), glyoxal bis(acrylamide) or butadiene.

21. Preformulated additive according to any one of claims 13 to 20, characterized in that at least 70% of the total mass of the polymer (P) is formed from hydrophobic units (N) and in that, when they are present, the hydrophilic units (F) represent not more than 30% of the total mass of the polymer (P) and the crosslinking units (R) represent not more than 20%, preferably not more than 10% and most particularly not more than 5% of the total mass of the polymer (P).

22. Preformulated additive according to claim 21, characterized in that the polymer (P) is an uncharged or non-ionizable polymer (P1) comprising
at least 70% of its weight of hydrophobic monomer units (N)
optionally at least 1% and preferably from 3% to 30% of its weight of uncharged or non-ionizable hydrophilic monomer units (F4)
optionally not more than 20% and preferably not more than 10% of its weight of uncharged or non-ionizable crosslinking units (R).

23. Preformulated additive according to claim 21, characterized in that the polymer (P) is a polymer (P2) containing anionic or anionizable units and being free of cationic or cationizable units, comprising
at least 70% of its weight of hydrophobic monomer units (N)
at least 1% of its weight, preferably from 3% to 30% of its weight and most particularly from 1% to 20% of its weight, of anionic or anionizable hydrophilic monomer units (F3)
optionally not more than 29% of its weight of uncharged or non-ionizable hydrophilic monomer units (F4).

24. Preformulated additive according to claim 21, characterized in that the polymer (P) is a polymer (P3) containing amphoteric units, comprising
at least 70% of its weight of hydrophobic monomer units (N)
at least 0.1% of its weight, preferably not more than 20% of its weight and most particularly not more than 10% of its weight, of amphoteric hydrophilic monomer units (F2)
optionally uncharged or non-ionizable hydrophilic monomer units (F4)
optionally cationic or cationizable hydrophilic monomer units (F1),
the combination of hydrophilic monomer units (F) preferably representing at least 1% of the weight of the polymer (P3), and the molar ratio of the cationic charges to the anionic charges possibly ranging from 1/99 to 80/20 depending on the desired use of said treatment composition.

25. Preformulated additive according to claim 21, characterized in that the polymer (P) is a polymer (P4) containing both cationic or cationizable units and anionic or anionizable units, comprising
at least 70% of its weight of hydrophobic monomer units (N)
cationic or cationizable hydrophilic monomer units (F1)
anionic or anionizable hydrophilic monomer units (F3)
optionally amphoteric hydrophilic monomer units (F2)
optionally uncharged or non-ionizable hydrophilic monomer units (F4), the combination of hydrophilic monomer units (F) preferably representing at least 1% of the weight of the polymer (P4), and the molar ratio of the cationic charges to the anionic charges possibly ranging from 1/99 to 80/20 depending on the desired use of said treatment composition.

26. Preformulated additive according to claim 21, characterized in that the polymer (P) is a polymer (P5) containing cationic or cationizable units and being free of anionic or anionizable units, comprising
at least 70% of its weight of hydrophobic monomer units (N)
at least 1% of its weight, preferably from 3% to 30% of its weight and most particularly from 1% to 10% of its weight, of cationic or cationizable hydrophilic monomer units (F1)
optionally not more than 20% of its weight of uncharged or non-ionizable hydrophilic monomer units (F4).

27. Preformulated additive according to any one of claims 1 to 26, characterized in that it comprises, in addition, in the encapsulated state in the particles of polymer (P), at least one hydrophobic active material (AM) chosen from the hydrophobic active materials usually present in the compositions for the treatment of textile fiber articles, preferably from the hydrophobic detergent active materials.

28. Preformulated additive according to claim 27, characterized in that the quantity of active material (AM) ranges from 20 to 70, preferably from 40 to 60 parts by weight per 100 parts by weight of polymer (P).

29. Preformulated additive according to claim 27 or 28, characterized in that the encapsulation of the hydrophobic active material (AM) by the nanoparticles of polymer (P) is carried out by introducing said active material (AM) into said particles of polymer (P) existing in the form of a nanolatex, the introduction of the active material (AM) being carried out either during the actual synthesis of said polymer by polymerization in aqueous emulsion, or after synthesis of said polymer by polymerization in aqueous emulsion.

30. Use, in a composition for the treatment textile fiber articles in an aqueous or wet medium, of the preformulated additive which is the subject of any one of claims 1 to 29, as care agent for said articles.

31. Use according to claim 30, as crease-resistance agent for said articles.

32. Use according to claim 30 or 31, characterized in that said composition comprises from 0.05 to 10% of said preformulated additive expressed as a polymer (P).

33. Use according to any one of claims 30 to 32, characterized in that said composition is provided
in the form of a solid or of a concentrated nonaqueous dispersion, placed in contact with the articles to be treated, after dilution in water;
in the form of a solid support comprising said preformulated additive, placed in contact directly with the articles to be treated in the dry or wet state.

34. Use according to any one of claims 30 to 33, characterized in that said composition is
a solid detergent formulation comprising from 0.05 to 5%, preferably from 0.1 to 3%, of said preformulated additive expressed as polymer (P), capable of directly forming, upon dilution, a washing bath;
a nonaqueous liquid detergent formulation comprising from 0.05 to 5%, preferably from 0.1 to 3%, of said preformulated additive expressed as polymer (P), capable of directly forming, upon dilution, a washing bath;
a rinsing and/or softening formulation comprising from 0.05 to 3%, preferably from 0.1 to 2%, of said preformulated additive expressed as polymer (P), capable of directly forming, upon dilution, a rinsing and/or softening bath;
a tumble dryer additive in a solid, in particular textile, material comprising from 0.05 to 10%, preferably from 0.1 to 5%, of said preformulated additive expressed as polymer (P), which is intended to be placed in contact with wet fabrics in a tumble dryer;
a washing additive comprising from 0.05 to 10%, preferably from 0.1 to 5%, of said preformulated additive expressed as polymer (P), intended to be deposited on dry fabrics prior to a washing operation using a detergent formulation containing or not containing said preformulated additive.

35. Use of the preformulated additive, comprising the polymer (P1), which is the subject of claim 22, optionally in combination with any one of claims 27 to 29, in a detergent formulation, in a rinsing and/or softening formulation, in a tumble dryer additive or in a washing additive.

36. Use of the preformulated additive, comprising the polymer (P2), which is the subject of claim 23, optionally in combination with any one of claims 27 to 29, in a detergent formulation, in a tumble dryer additive or in a washing additive.

37. Use of the preformulated additive, comprising the polymer (P3), which is the subject of claim 24, optionally in combination with any one of claims 27 to 29, in a tumble dryer additive when the ratio of the cationic charges to the anionic charges of the polymer (P) is 1/99 to 80/20, in a detergent formulation or in a washing additive when the ratio of the cationic charges to the anionic charges of the polymer (P3) is 1/99 to 60/40, preferably 5/95 to 50/50.

38. Use of the preformulated additive, comprising the polymer (P4), which is the subject of claim 25, optionally in combination with any one of claims 27 to 29, in a tumble dryer additive when the ratio of the cationic charges to the anionic charges of the polymer (P4) is 1/99 to 80/20, in a washing additive when the ratio of the cationic charges to the anionic charges of the polymer (P) is 1/99 to 60/40, preferably 5/95 to 50/50.

39. Use of the preformulated additive, comprising the polymer (P5), which is the subject of claim 26, optionally in combination with any one of claims 27 to 29, in a detergent formulation, in a rinsing and/or softening formulation, in a tumble dryer additive or in a washing additive.

40. Method of giving crease-resistance properties to textile fiber articles, by treating said articles in an aqueous or wet medium, using a treatment composition comprising at least one preformulated additive which is the subject of any one of claims 1 to 29, or whose use is the subject of any one of claims 30 to 39.

41. Composition for textile fiber article care comprising from 0.05 to 10% by weight, expressed as polymer (P), of at least one preformulated additive which is the subject of any one of claims 1 to 29.

42. Composition according to claim 41, characterized in that it is provided
in the form of a solid or of a concentrated nonaqueous dispersion, placed in contact with the articles to be treated, after dilution in water;
in the form of a solid support comprising said preformulated additive, placed in contact directly with the articles to be treated in the dry or wet state.

43. Composition according to claim 41 or 42, characterized in that it is
a solid detergent formulation comprising from 0.05 to 5%, preferably from 0.1 to 3%, of said preformulated additive expressed as polymer (P), capable of directly forming, upon dilution, a washing bath;
a nonaqueous liquid detergent formulation comprising from 0.05 to 5%, preferably from 0.1 to 3%, of said preformulated additive expressed as polymer (P), capable of directly forming, upon dilution, a washing bath;
a rinsing and/or softening formulation comprising from 0.05 to 3%, preferably from 0.1 to 2%, of said preformulated additive expressed as polymer (P), capable of directly forming, upon dilution, a rinsing and/or softening bath;
a tumble dryer additive in a solid, in particular textile, material comprising from 0.05 to 10% or preferably from 0.1 to 5%, of said preformulated additive expressed as polymer (P), which is intended to be placed in contact with wet fabrics in a tumble dryer;
a washing additive comprising from 0.05 to 10%, preferably from 0.1 to 5%, of said preformulated additive expressed as polymer (P), intended to be deposited on dry fabrics prior to a washing operation using a detergent formulation containing or not containing said preformulated additive.

44. Composition according to claim 43, characterized in that it is a detergent formulation and in that said preformulated additive is chosen from those which are the subject of any one of claims 22, 23, 24, 26 and comprising respectively a polymer (P1), (P2), (P3) for which the ratio of the cationic charges to the anionic charges is 1/99 to 60/40, preferably 5/95 to 50/50, (P5), optionally in combination with any one of claims 27 to 29.

45. Composition according to claim 43, characterized in that it is a rinsing and/or softening formulation and in that said preformulated additive is chosen from those which are the subject of claim 22 or 26 and comprising a polymer (P1) or (P5), optionally in combination with any one of claims 27 to 29.

46. Composition according to claim 43, characterized in that it is a tumble dryer additive and in that said preformulated additive is chosen from those which are the subject of any one of claims 22, 23, 24, 25, 26 and comprising respectively a polymer (P1), (P2), (P3), (P4), (P5), optionally in combination with any one of claims 27 to 29.

47. Composition according to claim 43, characterized in that it is a washing additive and in that said preformulated additive is chosen from those which are the subject of any one of claims 22, 23, 24, 25, 26, and comprising respectively a polymer (P1), (P2), (P3) for which the ratio of the cationic charges to the anionic charges is 1/99 to 60/40, preferably 5/95 to 50/50, (P4) for which the ratio of the cationic charges to the anionic charges is 1/99 to 60/40, preferably 5/95 to 50/50, (P5), optionally in combination with any one of claims 27 to 29.
